(19) United States
(12) Patent Application Publication
(10) Pub. No.: US 2005/0102876 A1
(43) Pub. Date: May 19, 2005

(54) Garment label

(76) Inventor: Douglas J. Kelly, Tustin, CA (US)

Correspondence Address: James R. Brueggemann, Esquire;Sheppard, Mullin, Richter & Hampton LLP, 48th Floor, 333 South Hope Street, Los Angeles, CA, 90071-1448, US

(21) Appl. No.: 10/714,275

(22) Filed: Nov. 14, 2003

(51) Int. Cl. G09F 3/18

(52) U.S. Cl. 40/661.04

(57) ABSTRACT

A garment label is provided that can be affixed to a garment in a permanent, yet, removable manner. The garment label provides indicia viewable thereon. The indicia include country of origin, garment provider identifier, and fiber content for the garment. Care instructions and garment size can also be included. A garment label can include a planar member and an attachment mechanism that facilitates optional removal and reattachment, if desired, without significant risk of damage to the garment. For example, a piercing element, or optionally a plurality of piercing elements, extends from the planar display members and is received by corresponding hole defined in a backing member. The holes can be curved and terminate within the backing member such that a corresponding piercing element of the plurality of piercing elements is bent once received within the holes. Optionally, garment label can further provide information in an encoded data element.

### BACKGROUND OF THE INVENTION

The present invention relates generally to garments, more particularly, to garment labels.

Garments labels serve several functions, such as, product association and promoting consumer loyalty, as well as statutory compliance. A complex array of statutes and regulations exist regarding disclosure requirements for textiles and garments. A garment is required to be marked with information considered to be important to the ultimate purchaser. The required information includes, for example, fiber content, country of origin, care instructions, and the identity of the manufacturer or another business responsible for marketing or handling the item. Specific statutes also are directed to labels containing regular care information and instructions for garments. Care labels must be permanently and securely attached and must be legible during the useful life of the product. Additional detail regarding labeling requirements can be found in What Every Member of the Trade Community Should Know About: Marking Requirement for Wearing Apparel (U.S. Customs Service, September 1999), which is herein incorporated by reference.

The consequences of improper labeling can be significant. For example, the U.S. Customs Service can refuse entry into the U.S. to any garment shipment having non-compliant labeling. Moreover, violators are subject to enforcement actions and substantial penalties for each offense. Due to the complexity of labeling requirements, most garment manufacturers simply implement well-known approaches for labeling.

In a typical approach, all of the required information is placed on a polyester label sewn along one edge of the label into a primary seam of the garment. For example, labels for shirts are sewn to a primary seam connecting the collar of the shirt. A care label can be provided separately, often located along a primary side seam.

Although current labeling approaches are generally effective, there are significant shortfalls. For example, advancements in garment material, as well as, modern garment styles can be incompatible with current labeling practices. A sewn-in label can damage the material; and modern styles, including modern seam construction, can leave little room for attachment. Also, consumers who are sensitive about their appearance may be uncomfortable with the possibility of a tag protruding unattractively above a shirt or blouse collar. Although exceptions to certain labeling requirement are available upon written request, the time and effort required makes obtaining such exceptions impractical for many garment providers.

As current labels are often made of polyester material, they can be fairly rigid. As a result, such labels can be an irritant to the wearer and negatively affect the comfort of the garment. Some wearers have taken to removing such labels from their garments, typically by cutting the label. For example, consumers who are sensitive about their proportions may be uncomfortable leaving size labels in their garment. Similarly, consumers who are sensitive about their finances or shopping habits may be uncomfortable with labeling that indicates a particular store or manufacturer. Regardless of the underlying rationale, if precise care is not taken during removal, the wearer can inadvertently damage the garment by cutting or unraveling the primary seam or cutting the garment itself. If the label is not cut close enough to the garment, then remaining the stub can be an even greater irritant to the wearer.

It should, therefore, be appreciated there exists a need for a garment label in compliance with relevant laws and regulations that facilities advancement in garments and that does not detract from the comfort of the garment, while enabling optional removal by the wearer, if desired, without significant risk of damage. The present invention fulfills this need and others.

### SUMMARY OF THE INVENTION

Briefly, and in general terms, the invention provides a garment label that can be affixed to a garment in a permanent, yet, removable manner, in compliance with relevant requirements. The garment label provides indicia viewable thereon. The indicia may include country of origin, garment provider identifier, and fiber content for the garment. Care instructions and garment size can also be included. The garment label facilitates optional removal and reattachment, if desired. Thus, those consumers that prefer to disassociate such information from their garments can do so, without significant risk of damage to the garment. Optionally, garment label or attachment element can further provide information via an encoded data element, which can be disposed in a portion of the label.

More particularly, and by way of example only, a garment label in accordance with the invention can include a planar member and a backing member. The planar member includes indicia providing compliant information about the garment that is viewable on the planar member. A piercing element, or optionally a plurality of piercing elements, extends from one of the members and is received by corresponding hole defined in the second member such that the garment label is permanently and securely affixed a garment. In a preferred embodiment, the holes of the backing member are curved and terminate within the backing member such that a corresponding piercing element of the plurality of piercing elements is bent once received within the holes.

In another preferred embodiment, the piercing elements extend through the holes and secured in place to engage the backing member. For example, the piercing elements can extend through the holes and be thermally or mechanically deformed to engage the backing member or otherwise, thermally or chemically welded together.

In yet another preferred embodiment, the garment label includes a planar display and a separable attachment mechanism, and has indicia viewable thereon. The attachment mechanism facilitates optional removal and reattachment to the garment, if desired. Optionally, the attachment mechanism includes a non-piercing element configured to enable removal and reattachment of the planar member to the garment.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1A is an exploded cross-sectional view of a first embodiment of a garment label in accordance with the invention, depicting a planar member, attachment mechanism and a backing portion.

FIG. 1B is a cross-sectional view of the garment label of FIG. 1, depicting the planar member secured to the backing portion.

FIG. 2 is a plan view of the garment label of FIG. 1, depicting indicia for country of origin, care instructions, RN, fiber content, and garment size.

FIG. 3A is an exploded cross-sectional view of a second embodiment of a garment label in accordance with the invention.

FIG. 3B is a cross-sectional view of the garment label of FIG. 3A.

FIG. 4A is an exploded cross-sectional view of a third embodiment of a garment label in accordance with the invention.

FIG. 4B is a cross-sectional view of the garment label of FIG. 4A.

FIG. 4C is a cross-sectional view of the garment label of FIG. 4A.

FIG. 5 is a front view of a fourth embodiment of a garment label in accordance with the invention.

FIG. 6 is an exploded perspective view of the garment label of FIG. 5.

FIG. 7 is a side view of a fifth embodiment of a garment label in accordance with the invention.

### DETAILED DESCRIPTION OF THE PREFERRED EMBODIMENTS

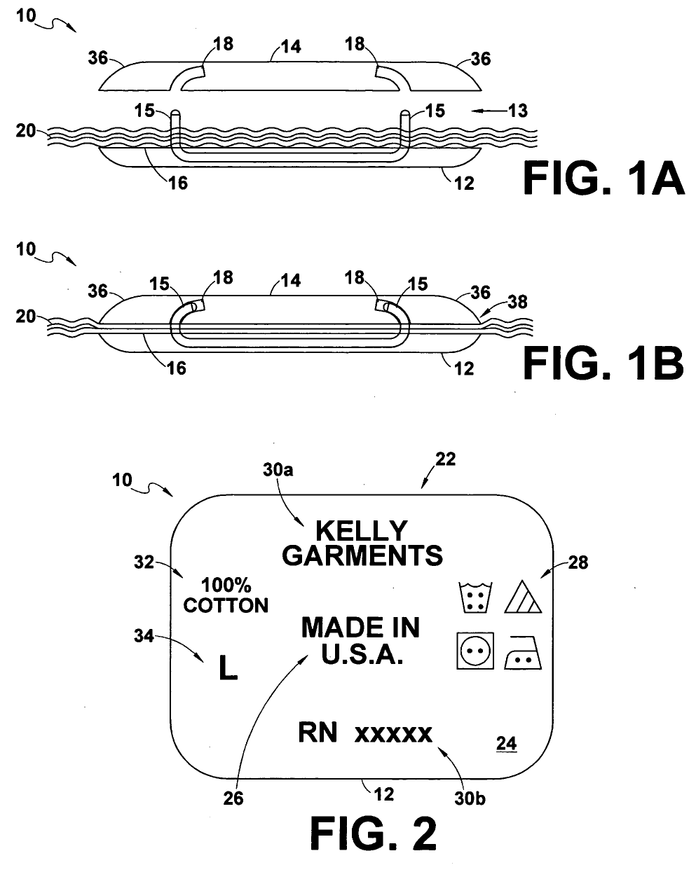

With reference to the illustrative drawings, and particularly FIGS. 1A and 1B, there is shown a garment label 10 having a planar display 12 and an attachment 13. The attachment includes two piercing elements 15 extending from a rear side 16 of the planar display and a backing member 14, defining holes 18 for receiving the piercing elements. In this manner, the garment label is permanently and securely affixed to a garment 20 in compliance with relevant requirements. Moreover, indicia 22 (FIG. 2) providing compliant information about the garment are viewable on the planar display.

With reference to FIG. 2, the indicia 22 are arranged on the planar display 12 to be easily legible from a front side 24 thereof. In this embodiment, indicia for country of origin 26, care instructions 28, garment provider identifiers 30a, 30b, fiber content 32, and garment size 34 are provided, in accordance with relevant rules. Here, both the company name 30a and the Registered Identification Number (RN) 30b are provided, however, use of both is not required. Of course, the required information can be distributed among multiple labels. The care instructions 28, as shown, are compliant with those provided by the American Society for Testing and Materials (ASTM), Standard D5489-96c. Alternatively, other care instructions can be used, such as, care symbols of the International Standards Organization (ISO), or properly worded care instructions. According to current regulations, care instructions must be attached prior to sale; although, they are not required for entry to the United States.

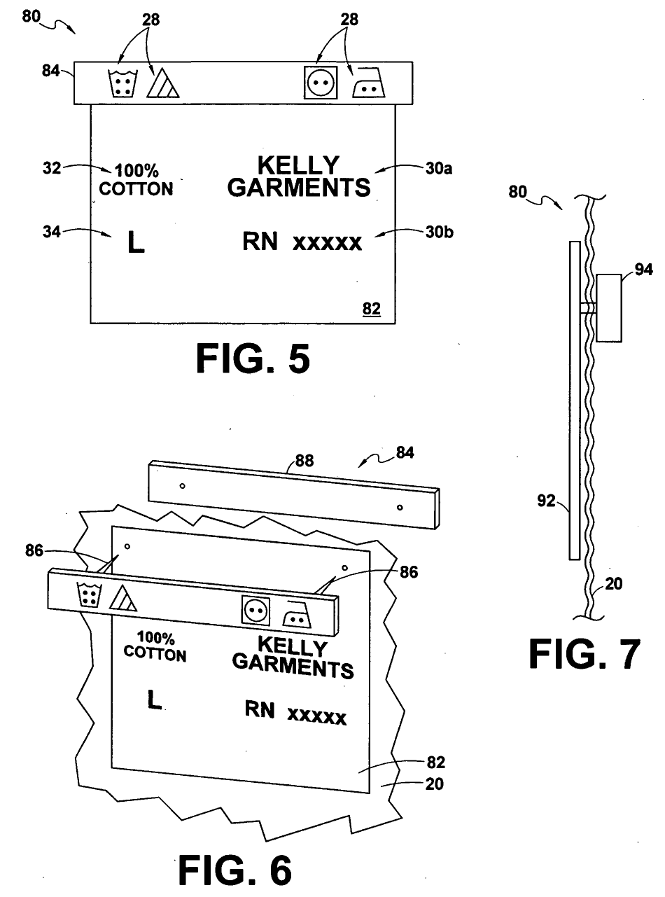

As further discussed below, other embodiments are contemplated in which various subsets of the indicia 22 are provided by the garment label. For example, garment size and/or care instructions can be provided on a second garment label, or excluded entirely. Also, the indicia can be provided on the backing member 14, or a second planar display (FIG. 5), such as a fabric display, can be disposed between the planar display 12 and the backing member 14.

The garment label can further provide information in an encoded data element (not shown), e.g., Automatic Identification and Data Capture (AIDC) technology such as a radio frequency identification (RFID) tag, magnetic storage device, barcodes, and devices implementing Bluetooth™ wireless technology. Such data elements can reside in the garment label itself or to another fastening element such as the staple, rivet, button or backing member to store or retrieve data from a garment. Tracking or tagging encoded data elements presents several advantages to manufactures and vendors but raises privacy concerns to consumers who may be sensitive to the potential of being tracked or tagged by permanent attachments to their clothing. Incorporating such encoded data elements in a removable garment label or attachment element will allow consumers to supervise the removal and discarding/recycling of the data element at the point of purchase. Similarly, theft-deterrent tags are attached to clothing until purchase and are considered in this document to be another form of encoded data element. The removal of such theft-deterrent tags at the point of purchase makes them particularly attractive for attaching labels which can also be removed at the point of purchase.

With reference again to FIG. 1B, the holes 18 of the backing member 14 are inwardly curved relative to side edges 36 and terminate within the backing member. The piercing elements preferably are formed of metal such that, once received within the holes, they bend to conform to the curved holes while having sufficient structural integrity to maintain the planar display secure to the backing member. The garment label facilitates optional removal and reattachment, if desired. Thus, those consumers that prefer to disassociate such information from their garments can do so without significant risk of damage to the garment. To remove, the backing member can be pried apart at a pry point 38. The piercing elements will then straighten allowing for easy removal of the planar display from the garment 20. The consumer can also put the garment label back simply by aligning and pressing the backing member and planar display together.

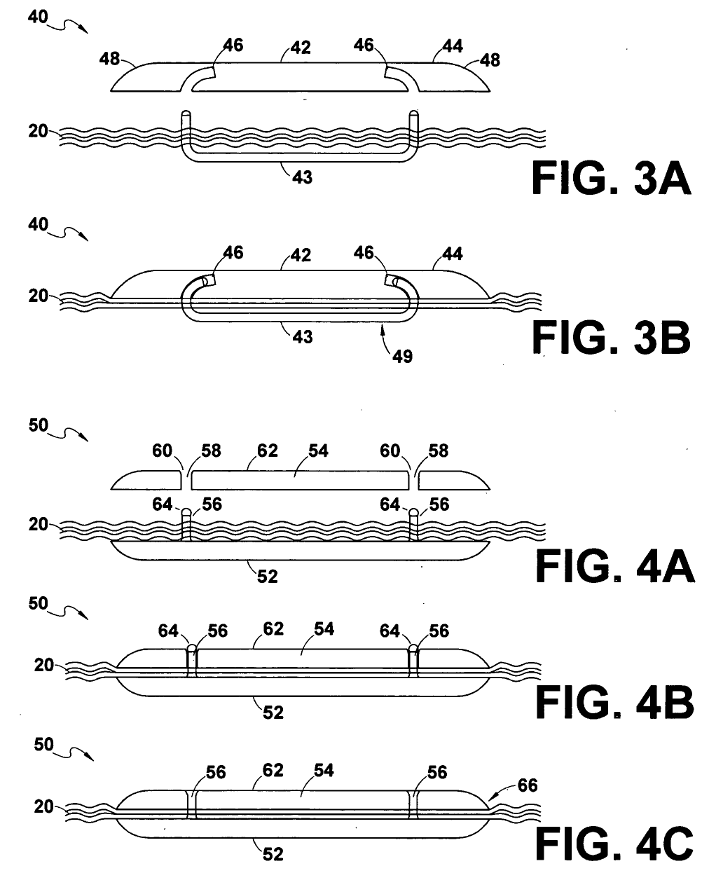

With reference now to FIGS. 3A and 3B, another preferred embodiment of a garment label 40 is shown. In this embodiment, the garment label includes a planar member 42, a multi-pronged securement device 43, and indicia 22 (FIG. 2), as previously discussed, are viewable for a front side 44 of the planar member. The planar member defines two holes 46 that are inwardly curved relative to side edges 48. The holes terminate within the planar member such that a corresponding piercing element is bent once received within the holes. To remove, the planar member can be pried apart at a pry point 49.

With reference now to FIGS. 4A-4C, yet another preferred embodiment of a garment label 50 is shown, having a planar display 52 and backing member 54, preferably of a plastic material. Two piercing elements 56 extend from the planar display and are received within holes 58 defined in the backing member. Each hole has an enlarged portion 60 approximate to an outer surface 62 of the backing member. Each enlarged portion interacts with a corresponding enlarged end 64 to secure the garment label in place. As shown in FIG. 4C, the piercing elements, optionally, can be secured in place to further enhance securement of the garment label. For example, the piercing elements can extend through the holes and be thermally or mechanically deformed to engage the backing member or otherwise, thermally or chemically welded together. Removal can be achieved by prying apart the planar display and backing member at a pry point 66.

With reference now to FIGS. 5 and 6, another exemplary embodiment of a garment label 80 is shown having a separable planar display 82 and an attachment mechanism 84. Indicia, such as those discussed above, are viewable on the garment label. In this embodiment, indicia for garment provider identifiers 30a, 30b, fiber content 32, and garment size 34, are found on the planar display, whereas care instructions 28 are viewable from on a front of the attachment. In this manner, the purchaser of the garment 20 can selectively disassociate indicia from the garment. Optionally, all indicia can be found on the planar display.

The attachment mechanism 84 facilitates optional removal and reattachment to a garment 20, if desired. Thus, those consumers that prefer to disassociate such information from their garments can do so without significant risk of damage to the garment. In this embodiment, the attachment mechanism includes piercing elements 86 and a backing member 88 operably similar to the embodiment depicted in FIG. 1A. In other embodiments, a separate backing member can be provided for each piercing element. Optionally, the attachment mechanism can incorporate at least one rivet, or snap, for attaching the label to the garment.

Additional embodiments are contemplated having a separable planar display and an attachment mechanism configured for removal and reattachment to the garment. For example, the attachment device can be configured with non-piercing attachments, such as, magnetic backings. In yet another embodiment, the securing device can be configured of one part, free of a separate backing element, wherein the securing device includes at least one bendable piercing element. For example, the securing device can be configured as a prismatic, or flattened, staple having one or more metal piercing elements with rounded ends to minimize the possibility of injury after removal. The piercing elements, preferably, would pierce the garment and bend inwardly to meet. In a detailed aspect of an exemplary embodiment, the backing member is generally flat to facilitate comfort. Also, in various embodiments discussed, the garment can be constructed with holes through which the piercing elements extend.

The attachment mechanism also can incorporate non-piercing means of securement. For example, as shown in FIG. 7, a button 94 can be provided on a back side of a planar display 92, with a corresponding buttonhole provided on the garment 20, or the planar display can define a buttonhole to receive a button of the garment (not shown). Additional embodiments are contemplated in which a cloth garment label is attached to the garment by means various joining processes such as welding, flaring, peening or gluing. Moreover, each of the aforementioned embodiments can further include an encoded data element.

It should be appreciated from the foregoing that the present invention provides a garment label that can be affixed to the garment in a permanent, yet, removable manner. In an exemplary embodiment, the garment label includes a planar member and a backing member. The planar member includes indicia providing compliant information about the garment that is viewable on the planar display. The indicia can include country of origin, garment provider identifier, and fiber content for the garment. Care instructions and garment size can also be included. A plurality of piercing elements extend from one of the members and are received by a plurality of holes defined in the second member such that the garment label is permanently and securely affixed a garment. The garment label facilitates optional removal and reattachment, if desired. Thus, those consumers that prefer to disassociate such information from their garments can do so, without significant risk of damage to the garment.

Although the invention has been disclosed in detail with reference only to the preferred embodiments, those skilled in the art will appreciate that additional garment tags can be made without departing from the scope of the invention. Accordingly, the invention is defined only by the claims set forth below.

1. A garment label, comprising:
a planar member having a front side and a rear side;
an attachment mechanism having
a rigid piercing element extending from the rear side of the planar member, and
a backing member defining a hole aligned to receive the piercing element; and
indicia including country of origin, garment provider identifier, and fiber content.

2. A garment label as defined in claim 1, the indicia further including care instructions.

3. A garment label as defined in claim 1, wherein:
the indicia further include garment size, and
the garment provider identifier is a Registered Identification Number (RN).

4. A garment label as defined in claim 1, wherein the planar member has a maximum thickness between about 1 mm and about 5 mm.

5. A garment label as defined in claim 1, the backing member has a maximum thickness between about 1 mm and about 5 mm.

6. A garment label as defined in claim 5, wherein the hole is curved and terminates within the backing member such that the piercing element is bent once received within the hole.

7. A garment label as defined in claim 5, wherein the piercing element extends through the hole and is joined in place.

8. A garment label as defined in claim 1, wherein:
the attachment mechanism includes a plurality of rigid piercing elements; and
the backing member defines a plurality of holes, each aligned with a corresponding piercing element.

9. A garment label as defined in claim 8, wherein each of the plurality of holes is curved and terminates within the backing member such that a corresponding piercing element of the plurality of piercing elements is bent once received within the holes.

10. A garment label as defined in claim 8, wherein the indicia are viewable on the planar member.

11. A garment label as defined in claim 8, further comprising an encoded data element.

12. A garment label as defined in claim 8, further comprising a radio frequency identification (RFID) device.

13. A garment label, comprising:
a planar member having
a front side,
a rear side, and
indicia including country of origin, garment provider identifier, and fiber content, the indicia being viewable on the planar member; and
an attachment mechanism separable from the planar member and having a rigid piercing element that extends through the planar member and the garment.

14. A garment label as defined in claim 13, wherein the attachment mechanism further includes a backing member aligned to receive the piercing element.

15. A garment label as defined in claim 13, wherein the attachment mechanism further includes a second rigid piercing element spaced apart from the first piercing element, both piercing elements configured to be bent to secure the garment label in place.

16. A garment label as defined in claim 13, wherein the rigid piercing element is rivet.

17. A garment label as defined in claim 13, wherein the rigid piercing element is a first piece of a two-piece snap, wherein the an attachment mechanism further includes the second piece of the two-piece snap for receiving the first piece of the snap.

18. A garment label as defined in claim 13, wherein the attachment mechanism includes care instructions viewable thereon.

19. A garment label as defined in claim 13, wherein:
the attachment mechanism includes a plurality of rigid piercing elements; and
a backing member that defines a plurality of holes, each aligned with a corresponding piercing element.

20. A garment label as defined in claim 19, wherein each of the plurality of holes is curved and terminates within the backing member such that a corresponding piercing element of the plurality of piercing elements is bent once received within the holes.

21. A garment label, comprising:
a planar member having
a front side,
a rear side, and
indicia including country of origin, garment provider identifier, and fiber content, the indicia being viewable on the planar member; and
an attachment mechanism, including a non-piercing element, that is configured to enable removal and reattachment of the planar member to the garment.

22. A garment label as defined in claim 21, wherein the non-piercing element is a button attached to the rear side of the planar member that cooperates with a buttonhole defined in the garment to enable removal and reattachment of the planar member to the garment.

23. A garment label as defined in claim 21, wherein the non-piercing element is a button attached to the garment that cooperates with a buttonhole defined in the planar member to enable removal and reattachment of the planar member to the garment.

24. A garment label as defined in claim 21, wherein the non-piercing element is a first piece of a two-piece snap attached to the planar member, wherein further the second piece of the two-piece snap is attached to the garment.

25. A garment label as defined in claim 21, further comprising a radio frequency identification (RFID) device.

26. A garment label, comprising:
a planar member;
an attachment mechanism separable from the planar member, the attachment mechanism having
a body,
a rigid piercing element that extends from the body through the planar member and the garment, and
a backing member aligned to receive the piercing element through the garment; and
indicia including country of origin, garment provider identifier, size, care instructions, and fiber content, wherein each indicium is viewable on either the body of the attachment mechanism or the planar member.

27. A garment label as defined in claim 26, wherein the indicium for size is on the planar member.

28. A garment label as defined in claim 27, wherein the care instructions are on the backing of the attachment mechanism.

29. A garment label as defined in claim 28, wherein the indicia for garment provider identifier and fiber content are on the planar member.

30. A garment label as defined in claim 26, wherein:
the attachment mechanism includes a plurality of rigid piercing elements; and
a backing member that defines a plurality of holes, each aligned with a corresponding piercing element.

31. A garment label as defined in claim 30, wherein each of the plurality of holes is curved and terminates within the backing member such that a corresponding piercing element of the plurality of piercing elements is bent once received within the holes.

32. A garment label as defined in claim 31, wherein the indicium for size is on the planar member, the care instructions are on the backing of the attachment mechanism.

33. A garment label as defined in claim 32, wherein the indicia for garment provider identifier and fiber content are on the planar member.
